(19) United States
(12) Patent Application Publication
(10) Pub. No.: US 2009/0243415 A1
(43) Pub. Date: Oct. 1, 2009

(54) Pole Tooth With Permanent Magnet

(75) Inventor: Thomas Hoppe, Lemgo (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/441,821

(22) PCT Filed: Sep. 13, 2007
(86) PCT No.: PCT/EP07/59668

§ 371 Date: Mar. 18, 2009

(30) Foreign Application Priority Data
Sep. 19, 2006 (DE) 10 2006 043 893.0

(51) Int. Cl. H02K 1/17; H02K 15/03

(52) U.S. Cl. 310/154.11; 29/596

(57) ABSTRACT

Electrical machines with pole teeth which can be equipped with permanent magnets are intended to be capable of being produced more easily. For this purpose the invention provides for a cutout to be provided for each pole tooth, in which cutout magnet powder can be compressed. In a corresponding method for producing a pole tooth of an electrical machine, a cutout of the pole tooth is filled with magnet powder, after which the magnet powder is compressed in the cutout.

The present invention relates to a pole tooth and an electrical machine having a first part, which has at least one pole tooth which is fitted with a permanent magnet, and a second part which magnetically interacts with the first part in order to move relative to one another. By way of example, the first part is a rotor of the electrical machine, with the second part being a stator of the electrical machine. The electrical machine need not be in the form of a rotating electrical machine but may also be a linear electrical machine, that is to say for example a linear motor. In this case, for example, the first part is the primary part of the linear electrical machine, and the second part is the secondary part of the linear electrical machine. Electrical machines can be designed such that the primary part and/or the secondary part may have permanent magnets. The primary part is in this case that part which has windings through which electric currents can be passed. This also relates, for example, to torque motors.

Furthermore, the present invention relates to a corresponding method for production of a pole tooth of an electrical machine.

The problem and the solution of the present invention will be described in the following text predominantly with reference to a linear motor, although the solution is not restricted to this, but can also advantageously be used, for example, for a rotating electrical machine, such as a permanent-magnet synchronous machine or torque motors.

By way of example, German Patent Application DE 10 2004 045 992.4 discloses a synchronous linear motor having a secondary part without any permanent magnets. There, the permanent magnets are fitted to the primary part of the synchronous linear motor in such a way that the secondary part does not itself contribute to the production of a magnetic field. The design of linear motors of this type requires strong permanent magnets to be integrated in the primary part. However, from the manufacturing point of view, it is extremely difficult to handle strong magnetized permanent magnets during the individual manufacturing stages. Furthermore, the heavy, strongly magnetized parts result in a high risk of injury.

Furthermore, synchronous linear motors are known which have magnets arranged in the air gap area. Permanent magnets may also be fitted in a secondary part. In the case of synchronous linear motors with embedded permanent magnets, it is disadvantageous, for example, that very great care and a large amount of effort are required to manufacture the permanent-magnet secondary part, which has the permanent magnets. The permanent magnets may be produced in different shapes (for example in block form, disk form, loaf-of-bread form, . . . ) and are dimensionally stable. The permanent magnets can be processed further by a motor manufacturer. This further processing is done, for example, by adhesively bonding onto a secondary part.

The object of the present invention is to find a cost-effective design of a pole tooth, and a corresponding method for production.

According to the invention, this object is achieved by:
a pole tooth which has the features as claimed in claim 1,
a pole tooth module which has the features as claimed in claim 6 and/or
a method for production of a pole tooth, having the features as claimed in claim 9.

Advantageous developments of the invention are specified in the dependent claims 2 to 5, 7, 8 and 10 to 13.

A pole tooth according to the invention is designed such that it has a cutout, with magnetic powder being pressed in the cutout. This has the advantage that it is no longer necessary to fit permanent magnets into a cutout in a pole tooth. This process is highly complex, because of the high magnetic forces on permanent magnets and the magnetic characteristic of the pole tooth. By way of example, the magnetic powder is pressed by means of a ram which has a shape which corresponds to the shape of the cutout. The cutout is in this case used as a type of mold for the magnetic powder to be pressed.

The magnetic powder is advantageously pressed in a type of magnet pocket which, after completion of the electrical machine, is entirely or partially filled by the pressed permanent magnet.

The cutout advantageously has not only one chamber for holding magnetic powder, but two or more chambers. One chamber represents a magnet pocket. Depending on the desired strength of the permanent magnet, one chamber of the cutout or else a plurality of chambers of the cutout can be filled with magnetic material.

In one advantageous refinement of the pole tooth, the pressed magnetic powder is formed such that it forms a solid body. In order to achieve this, the pressed magnetic powder is sintered and/or provided with a binding agent. The binding agent is, for example, an adhesive or else an impregnating resin. The sintering provides robustness for the magnetic powder, and in particular the sintering also makes it possible to positively influence the demagnetization field strength. The time period for sintering can advantageously be reduced since, for example, adhesive can be added even during the pressing process (pressing) thus resulting in a type of plastic-bonded magnet. For example, shrinkage of the sintered material can be reduced by reducing the temperature during the sintering process. The cavities which are created by the shrinkage are filled with a filling material, in one advantageous refinement. By way of example, the encapsulation compound which is used for encapsulation and/or impregnation of the windings, can be used as a filling material. In order to optimize the production process, the filling of the cavities and the encapsulation and/or the impregnation are advantageously carried out in one process step.

Furthermore, the pole tooth can also be designed to be laminated. In particular, lamination makes it possible to reduce eddy current losses. The cutout in the pole tooth is advantageously formed by means of the laminates of the laminated core of the pole tooth. In this case, the laminates are packed sufficiently densely that no significant amounts of magnetic powder material come between the laminates during the pressing process.

The pole tooth can also advantageously be designed such that this pole tooth has two pole tooth halves which have opposite end faces, with at least one end face laminate connecting one end face of each of the two pole tooth halves to one another such that the cutout is formed between the two pole tooth halves.

By way of example, an electrical machine is therefore designed such that pole teeth are fitted with permanent magnets, with one pole tooth having two pole tooth halves. In addition to pole tooth halves, each half of which has two opposite end faces, the pole tooth has at least one end face laminate which connects one end face of each of the two pole tooth halves to one another such that a pocket is formed as a cutout between the two pole tooth halves, into which pocket magnetic powder can be introduced. By way of example, the pole tooth halves are formed by means of laminated cores.

Each pole tooth half preferably comprises a laminated core. A core such as this can be produced with the desired height by conventional packing technology. The end face laminate can also be packed with the two pole tooth halves, if required.

In one specific embodiment, the pole tooth or the pole tooth halves may have a separable pole shoe. It is thus possible to push prefabricated coils onto the pole tooth, and the pole tooth need not be wound in the assembled state.

A pole tooth module can be formed from two or more pole teeth. The pole tooth module has two or more pole teeth, in which case the pole teeth may be designed as described above. Each pole tooth advantageously has at least one dedicated laminated core. It is thus possible to design a primary part and/or a secondary part of an electrical machine in a modular form.

In a further preferred embodiment, a pole tooth module can be produced with a plurality of pole teeth, as described above, with each pole tooth or each pole tooth half comprising a laminated core. In this case, it is possible to arrange a plurality of pole teeth adjacent to one another in the packing direction, and to use a common end laminate for two of the pole teeth, in each case. In this case, the pole tooth module virtually comprises a single overall pole tooth which is created by arranging a plurality of identical pole teeth in a row. By way of example, this makes it possible to match the size of the overall pole tooth to the corresponding size of the primary part in the packing direction.

However, the pole tooth module may also comprise a plurality of pole teeth which are arranged transversely with respect to the packing direction, with the end laminates of the plurality of pole teeth being integrally connected to one another. By way of example, this allows the pole teeth to be connected to one another via one common end laminate over the entire length of a primary part of a linear motor.

In a method for production of a pole tooth of an electrical machine, a cutout, which can be designed as described above, in the pole tooth is filled with magnetic powder, after which the magnetic powder is pressed in the cutout.

In order to solidify the magnetic powder, it is advantageous to heat it. For example, heating makes it possible to sinter the magnetic powder. If the magnetic powder has a binding agent such as an adhesive, then the adhesive characteristic of the adhesive can advantageously be activated by means of the heating. If the magnetic powder is heated for sintering and/or for forming an adhesively bonded joint, then the heating is advantageously carried out after the pressing process.

During the process of pressing the magnetic powder, it may be advantageous to produce a magnetic field which acts on the magnetic powder, with this resulting in the magnetic powder being aligned so as to allow more compact pressing.

In order to achieve the characteristics of a permanent magnet, the magnetic powder is magnetized. The magnetization is carried out after the pressing of the magnetic powder and/or after the heating of the magnetic powder.

In a further advantageous refinement of the method, transverse field pressing is carried out. In the case of transverse field pressing, the pressing direction is transverse with respect to the direction of magnetization. This makes it possible, for example, to achieve better remanence characteristics. In the case of transverse field pressing, the pressing is carried out, for example, at least at times in parallel with the process of generating a transverse magnetic field, which acts on the pressed magnetic powder.

If a pole tooth is intended to be wound with a coil, then the winding is advantageously carried out after the magnetization of the pressed magnetic powder.

If the winding process is carried out before the magnetization, then the current can also be passed through the winding in order to assist the magnetization process. This is particularly advantageous in the case of single teeth.

The present invention will now be explained in more detail with reference to the attached exemplary drawings, in which:

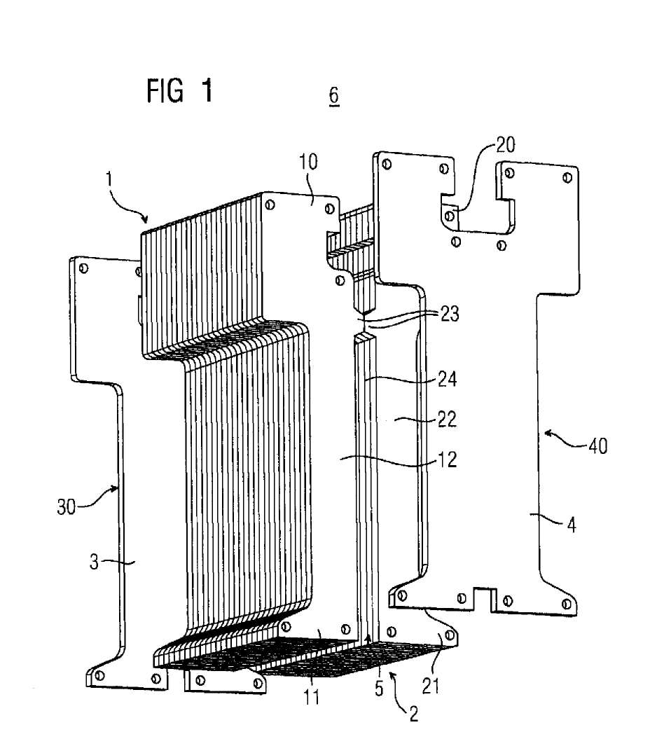

FIG. 1 shows a pole tooth according to the invention with end face laminates, in the form of an exploded view;

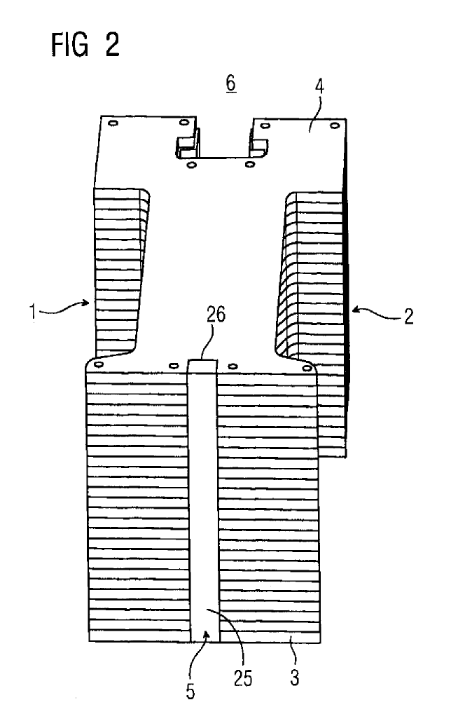

FIG. 2 shows the pole tooth from FIG. 1 in the assembled state;

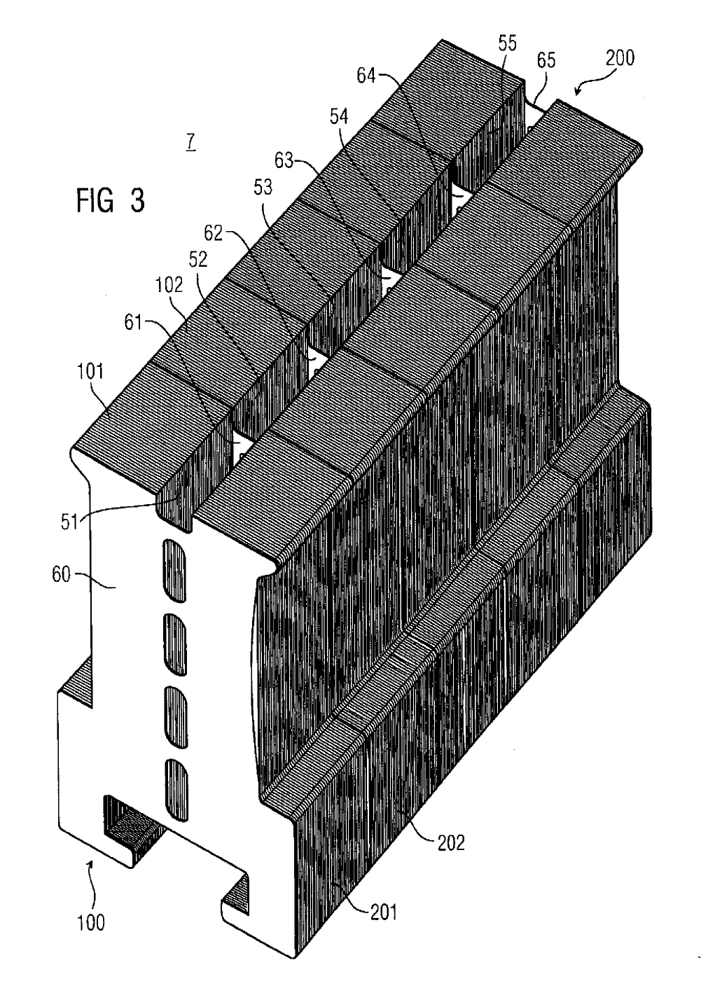

FIG. 3 shows a pole tooth module in the packing direction;

FIG. 4 shows a pole tooth module transverse with respect to the packing direction;

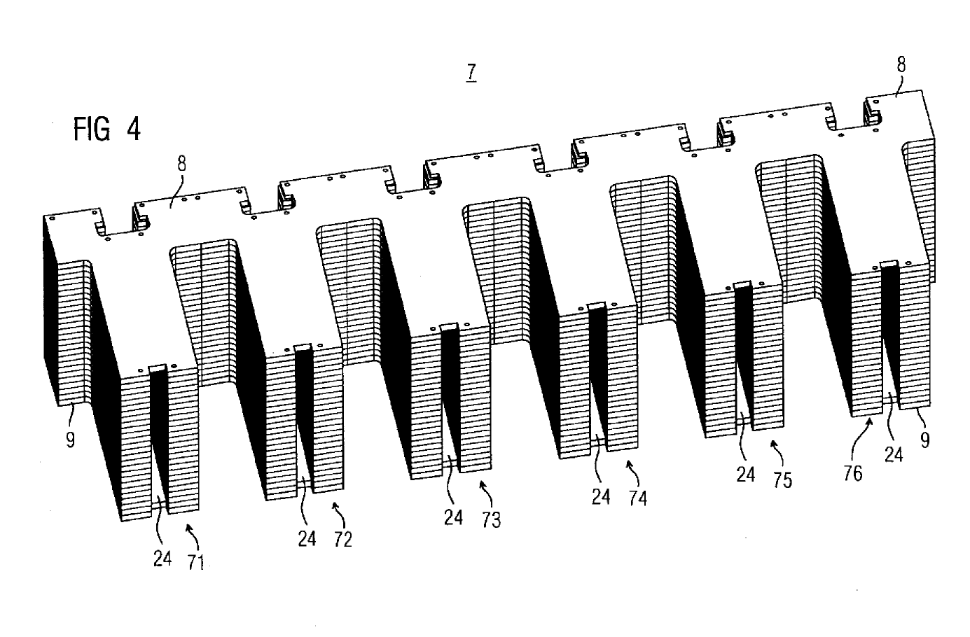

FIG. 5 shows a laminate section of a pole tooth which has a closed cutout;

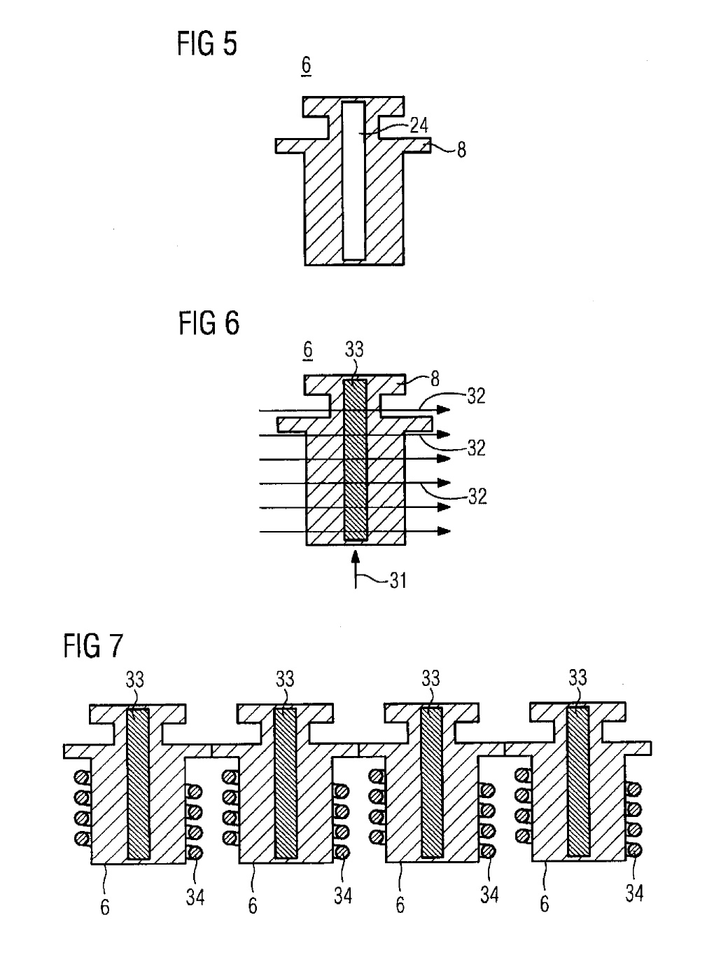

FIG. 6 shows transverse field pressing, and

FIG. 7 shows wound pole teeth.

The exemplary embodiments which will be described in more detail in the following text represent preferred embodiments of the present invention.

The pole tooth 6, which is shown in the form of an exploded view in FIG. 1, has two packed pole tooth halves 1 and 2. Furthermore, one end laminate 3 and 4 is arranged on each of the two end faces.

The pole tooth halves 1, 2 essentially have a C-shaped structure, with one of the ends being formed by the pole tooth heads 10, 20, and the other ends being formed by pole shoes 11, 21. The center areas 12, 22 of the pole tooth halves are essentially in the form of plates. The two pole tooth halves 1 and 2 are arranged such that a gap or a pocket 5 is created between them and their center areas 12, 22. This pocket is used as a cutout 24 which can be filled with magnetic powder. In order to hold the magnetic powder in the cutout, the laminates of the pole tooth halves have end tabs 23. The end tabs 23 bound the cutout. In the present example, the end tabs 23 are positioned at the end of the waisted center areas 12, 22. The end tabs close the cutout 24 in one direction.

Each of the end laminates 3, 4 has the contour of the end faces of the two pole tooth halves 1, 2 including the gap 5 located between them. Each end face laminate 3, 4 therefore has a waisted center area 30, 40.

FIG. 2 shows the pole tooth from FIG. 1 in the assembled state. The two end face laminates 31 4 hold the two pole tooth halves 1, 2 at the desired distance apart, thus forming the pocket 5. Said elements 1 to 4 are connected to one another by stamping packeting or by some other packing technique (stove enamel, adhesively bonding, welding, clamping, riveting, etc.). This results in a dimensionally stable pocket 5 in all cases. This dimensional stability makes it possible to use the pocket 5 as a mold for pressing the magnetic powder. This is particularly advantageous not only when assembling a primary part for a synchronous linear motor but also for manufacturing corresponding rotating drives.

As illustrated in FIG. 2, the pocket 5 may be closed by inserting a closure spring 25 into a slot 26. This closure spring 25 can also advantageously be used at this stage as a ram for pressing the magnetic powder.

FIG. 3 shows a further-developed embodiment of the present invention, illustrating a laminated pole tooth whose pole tooth halves 100, 200 are held at the desired distance apart by a plurality of continuous laminates 60, 61, 62, 63, 64 and 65. This in each case results in a row of five pockets 51, 52, 53, 54 and 55, which are aligned with one another and are separated by the laminates 60 to 65. Magnetic powder can be introduced into these pockets 51 to 55, and can be pressed.

The pole tooth illustrated in FIG. 3, can also be described as a pole tooth module 7, in which a plurality of individual pole teeth as shown in FIG. 2 are arranged one behind the other in the packing direction. In this case, one end face laminate can in each case be used for two laminated cores, which are arranged in a row with one another in the packing direction, as a spacer for the respective pole tooth halves. For example, the individual laminated cores 201 and 202, or 101 to 102, thus have the common end face laminate or spacing laminate 61. This also applies to the other individual laminated cores. The real end face laminates 60, 65, which form the end faces of the entire pole tooth, are fitted only to the free end faces of the pole tooth module. This allows a single pole tooth module to be used for the entire width of a primary part.

FIG. 4 illustrates a further embodiment of the present invention, in this case in the form of an elongated module with six pole teeth. In this example, six pole teeth as shown in FIG. 2 are therefore arranged in a direction transversely with respect to the packing direction, and are connected to one another. The individual pole teeth 71 to 77 are connected by means of two continuous end face laminates 8 and 9. These two end face laminates 8 and 9 are complete sections and not only hold the individual pole tooth halves of the pole teeth 71 to 76 at the desired distance apart, but also hold the pole teeth, which are arranged alongside one another, together at their pole tooth heads. Furthermore, the two end face laminates 8 and 9 bound the respective pockets, which are formed between the pole tooth halves, in the packing direction. This allows a pole tooth module 7 to be produced with the desired primary part length. A module such as this can also be combined with the module illustrated in FIG. 3, for example by inserting a further integral laminate, parallel to the end face laminates 8 and 9, into the laminated core arrangement. The cutouts 24 are intended to be filled with magnetic powder.

In the illustration shown in FIG. 4, it is additionally evident that the individual pole teeth 71 to 76 do not have salient pole shoes. This has the advantage that prefabricated coils can be pushed onto the pole teeth and, if required, special pole shoes can be fitted to the ends of the laminated cores after the coils have been fitted.

The illustration in FIG. 5 shows the laminate section of a pole tooth 6, with the laminate section having a closed cutout 24. The cutout 24 is advantageously stamped out of the laminate 8 such that the cutout 24 is always surrounded by the laminate. This has the advantage, for example, that it makes it possible to increase the robustness.

The illustration in FIG. 6 shows transverse field pressing. An arrow 31 represents the pressing direction of the magnetic powder 33 to be pressed. The arrows 32 represent the magnetization direction. The magnetization direction runs transversely with respect to the pressing direction 31.

The illustration in FIG. 7 shows pole teeth 6 which are arranged in a row with one another and have already had windings 34 wound on them. If a primary part of an electrical synchronous machine has both the windings and the permanent magnets, then the permanent magnets can be arranged in a buried form. Particularly in the case of buried permanent magnets, it is advantageous that a cutout can be filled with magnetic powder first of all in a simple manner, after which the magnetic powder is pressed, and after which the pressed magnetic powder is magnetized. The magnetic powder is pressed at a high pressure, such that the volume of the area occupied by the magnetic powder that has been introduced is reduced.

According to the invention, it is now no longer necessary to insert entire magnets into a cutout. In a similar manner to the manufacturing process for the permanent magnet, the cutout in the tooth can be used as a lost pressing mold, and the magnetic powder can actually be pressed directly into the tooth.

Since the magnet in a single tooth can be magnetized subsequently, the required field alignment can, of course, likewise be applied from the outside while the magnet is being pressed. This method therefore makes it possible to use so-called transverse field pressing.

A further advantage of the invention is that there is no need for any external machining of the magnet. This reduces the costs. Furthermore, any desired external shapes can be produced. The magnet tolerances also no longer play a major role since the magnetization is carried out on the tooth itself.

1-13. (canceled)

14. A pole tooth for an electrical machine, comprising:
a cutout having at least two chambers, with one of the chambers representing a magnet pocket; and
magnetic powder press-fitted in at least one of the chambers of the cutout.

15. The pole tooth of claim 14, wherein the magnetic powder is a sintered magnetic powder.

16. The pole tooth of claim 14, wherein the magnetic powder is a binding agent containing an adhesive or an impregnated resin.

17. The pole tooth of claim 14, having a laminated structure comprised of laminates configured to form the cutout.

18. The pole tooth of claim 14, having two pole tooth halves, each of which having two opposite end faces, further comprising end face laminates to connect the end faces on either side of the two pole tooth halves to one another such that the cutout is formed between the two pole tooth halves.

19. The pole tooth of claim 18, wherein each pole tooth half is made of a laminated core.

20. A pole tooth module, comprising a plurality of pole teeth, each pole tooth structured to form a laminated core and including a cutout having at least two chambers, with one of the chambers representing a magnet pocket, and magnetic powder filled in at least one of the chambers of the cutout.

21. The pole tooth module of claim 20, wherein a plurality of pole teeth are arranged adjacent to one another in a packing direction, with neighboring pole teeth being separated from one another by a single end laminate.

22. The pole tooth module of claim 20, wherein a plurality of pole teeth are arranged transversely with respect to a packing direction, further comprising single-piece end laminates extending on either end face of the plurality of pole teeth.

23. A method for production of a pole tooth of an electrical machine, comprising the steps of:
filling magnetic powder in a cutout of a pole tooth; and
pressing the magnetic powder in the cutout.

24. The method of claim 23, wherein the pressing step is a transverse field pressing step.

25. The method of claim 23, wherein the pressing step includes the step of applying a magnetic field to align the magnetic powder.

26. The method of claim 23, further comprising the step of heating at least one member selected from the group consisting of the pole tooth and the magnetic powder for sintering and/or forming an adhesively bonded joint by means of an adhesive.

27. The method of claim 23, wherein the heating step is executed after the pressing step.

28. The method of claim 23, further comprising the step of magnetizing the magnetic powder after the pressing step.

29. The method of claim 27, further comprising the step of magnetizing the magnetic powder after the heating step.
